(19) United States
(12) Patent Application Publication
(10) Pub. No.: US 2025/0291988 A1
(43) Pub. Date: Sep. 18, 2025

(54) SIMULATION METHOD, METHOD FOR PRODUCING SEMICONDUCTOR DEVICE, AND SEMICONDUCTOR DEVICE

(71) Applicant: RESONAC CORPORATION, Minato-ku, Tokyo (JP)

(72) Inventors: Hiroyuki HAMAGAMI, Chiyoda-ku, Tokyo (JP); Yasuhiko KATO, Chiyoda-ku, Tokyo (JP); Kohei SEKI, Chiyoda-ku, Tokyo (JP)

(21) Appl. No.: 18/861,221

(22) PCT Filed: Sep. 9, 2022
(86) PCT No.: PCT/JP2022/033968

§ 371 Date: Oct. 29, 2024

(51) Int. Cl. G06F 30/3308

(52) U.S. Cl. CPC G06F 30/3308

(57) ABSTRACT

A simulation method, including: preparing a simulation model of a semiconductor device that includes a substrate, an element, a connection that electrically connects the substrate and the element, and a reinforcement that is disposed at a periphery of the element; and calculating an amount of strain applied to the connection in the simulation model.

### TECHNICAL FIELD

The present disclosure relates to a simulation method, a method for producing a semiconductor device, and a semiconductor device.

### BACKGROUND ART

In a typical method of assembling a semiconductor package, an element such as a semiconductor chip is disposed on a substrate via an electroconductive connection such as solder, and a space around the connection is filled with a resin material referred to as an underfill material. Improvements in the properties of the resin material in order to satisfy requirements corresponding to the intended use of the resin material have been considered. For example, Patent Document 1 describes an underfill material that achieves both of suppression of increase in the rate of thermal expansion after curing and a reduction in viscosity during a filling process, by including an aminophenol-type epoxy resin in the underfill material.

### PRIOR ART DOCUMENT

### Patent Document

Patent Document 1: Japanese Patent Application Laid-Open (JP-A) No. 2019-011409

### SUMMARY OF THE INVENTION

### Problem to be Solved by the Invention

In association with the recent dissemination of the 5th generation mobile communication system (5G), new issues have been arising in the packaging techniques for semiconductor packages used in communication devices and the like. For example, the possibility that a commonly-used resin material may cause a reduction in the transmission efficiency of high-frequency electromagnetic waves, and consequently a delay in communication or the like, has been discussed. Therefore, a configuration in which a reinforcement is disposed only at a periphery of an element, instead of filling a space around the connection with a resin material, has been studied.

In the configuration mentioned above, since the space around the connection is not filled with a resin material, the connection may be subjected to strain generated by the expansion and contraction of the reinforcement disposed at the periphery of the element, and may deteriorate. Therefore, the connection needs to secure a sufficient degree of strength with this configuration.

In light of the foregoing, an embodiment of the present disclosure aims to provide a simulation method that can analyze the strength of a connection between an element and a substrate with high accuracy. A further embodiment of the present disclosure aims to provide a method for producing a semiconductor device and a semiconductor device that exhibit excellent strength of connection between an element and a substrate.

### Means for Solving the Problem

<1> A simulation method, including:
preparing a simulation model of a semiconductor device that comprises a substrate, an element, a connection that electrically connects the substrate and the element, and a reinforcement that is disposed at a periphery of the element; and
calculating an amount of strain applied to the connection in the simulation model.
<2> The simulation method according to <1>, further comprising deriving a polynomial approximate curve of degree N, represented by the following formula (1):

$$Y = {aX}^{N} + {cX}^{( N - 1 )} + {dX}^{( N - 2 )} + … + b \qquad Formula ( 1 )$$

wherein, in formula (1), a, b, c and d are arbitrary constants and N is an integer of 2 or more.
<3> The simulation method according to <1> or <2>, wherein the simulation model is produced using a structural analysis software.
<4> A method for producing a semiconductor device that includes a substrate, an element, a connection that electrically connects the substrate and the element, and a reinforcement that is disposed at a periphery of the element,
the method including determining a cross-sectional area X of the reinforcement based on an amount of strain Y applied to the connection.
<5> The method for producing a semiconductor device according to <4>, wherein the cross-sectional area X of the reinforcement satisfies the following formula (2):

$${X}_{min} \times 0.7 \leq X \leq {X}_{min} \times 1.3 \qquad Formula ( 2 )$$

wherein, in formula (2), Xₘᵢₙ represents a cross-sectional area of the reinforcement when an amount of strain Y applied to the connection is at a minimum.
<6> The method for producing a semiconductor device according to <4>, wherein the amount of strain Y applied to the connection is calculated using a simulation model.
<7> The method for producing a semiconductor device according to <4>, wherein the reinforcement is a cured product of a curable resin composition.
<8> The method for producing a semiconductor device according to <7>, wherein the curable resin composition includes an epoxy resin.
<9> The method for producing a semiconductor device according to <5>, wherein the reinforcement has a glass transition temperature (Tg) of 100° C. or more, a thermal expansion coefficient in a region of not greater than the glass transition temperature (CTE 1) of 25 ppm/° C. or less, and a thermal expansion coefficient in a region of not less than the glass transition temperature (CTE 2) of 80 ppm/° C. or less.
<10> A semiconductor device that comprises a substrate, an element, a connection that electrically connects the substrate and the element, and a reinforcement that is disposed at a periphery of the element, the reinforcement having a cross-sectional area X that satisfies the following formula (2):

$${X}_{min} \times 0.7 \leq X \leq {X}_{min} \times 1.3 \qquad Formula ( 2 )$$

wherein, in formula (2), Xₘᵢₙ represents a cross-sectional area of the reinforcement when an amount of strain Y applied to the connection is at a minimum.
<11> The semiconductor device according to <10>, wherein the reinforcement is a cured product of a curable resin composition.
<12> The semiconductor device according to <10>, wherein the curable resin composition comprises an epoxy resin.
<13> The semiconductor device according to <10>, wherein the reinforcement has a glass transition temperature (Tg) of 100° C. or more, a thermal expansion coefficient in a region of not greater than the glass transition temperature (CTE 1) of 25 ppm/° C. or less, and a thermal expansion coefficient in a region of not less than the glass transition temperature (CTE 2) of 80 ppm/° C. or less.

### Effect of the Invention

According to an embodiment of the present disclosure, a simulation method that can analyze the strength of a connection between an element and a substrate with high accuracy is provided. According to a further embodiment of the present disclosure, a method for producing a semiconductor device and a semiconductor device that exhibit excellent strength of connection between an element and a substrate are provided.

### BRIEF EXPLANATION OF THE DRAWINGS

FIG. 1 is a schematic sectional view of a specific example of the configuration of the reinforcement.

FIG. 2 is a schematic sectional view of a specific example of the configuration of the reinforcement.

FIG. 3 is a schematic sectional view of a specific example of the configuration of the reinforcement.

FIG. 4 is a schematic sectional view of a specific example of the configuration of the reinforcement.

FIG. 5 is a schematic sectional view of a specific example of the configuration of the reinforcement.

FIG. 6 is a schematic plan view showing a method of forming the reinforcement of the sample prepared in the Examples.

FIG. 7 is a Weibull Plot graph produced from the results of the heat shock test conducted on the sample prepared in the Examples.

FIG. 8 is a graph showing a relationship between the cross-sectional area and the amount of strain of the simulation model prepared in the Examples.

### EMBODIMENTS OF IMPLEMENTING THE INVENTION

Embodiments for carrying out the present invention will now be described in detail. However, the invention is in no way limited to the following embodiments. In the following embodiments, constituent elements (including element steps and the like) of the embodiments are not essential, unless otherwise specified. Likewise, numerical values and ranges thereof are not intended to restrict the invention.

In the present disclosure, the definition of the term “step” includes not only an independent step which is distinguishable from another step, but also a step which is not clearly distinguishable from another step, as long as the purpose of the step is achieved.

In the present disclosure, any numerical range described using the expression “from . . . to . . . ” represents a range in which numerical values described before and after the “to” are included in the range as a minimum value and a maximum value, respectively.

In a numerical range described in a stepwise manner, in the present disclosure, an upper limit value or a lower limit value described in one numerical range may be replaced with an upper limit value or a lower limit value in another numerical range described in a stepwise manner. Further, in a numerical range described in the present disclosure, the upper limit value or the lower limit value in the numerical range may be replaced with a value shown in the Examples.

In the present disclosure, in a case in which a respective component in a composition includes plural kinds of substances, the content of the respective component refers to the total content of the plural kinds of substances present in the composition, unless otherwise specified.

In the present disclosure, particles corresponding to each component may include plural kinds of particles. In a case in which plural kinds of particles corresponding to each component are present in a composition, the particle size of each component refers to the value of the particle size of a mixture of the plural kinds of particles present in the composition, unless otherwise specified.

### <Simulation Method>

The simulation method according to the present disclosure includes: preparing a simulation model of a semiconductor device that includes a substrate, an element, a connection that electrically connects the substrate and the element, and a reinforcement that is disposed at a periphery of the element; and calculating an amount of strain applied to the connection in the simulation model.

In the present disclosure, the “periphery of the element” refers to a portion corresponding to an outline of the element or a neighborhood thereof, which may be either or both of the inside and the outside of a region corresponding to the element.

In the present disclosure, the “cross-sectional area of the reinforcement” refers to an area of a cross-section obtained by cutting the reinforcement along a thickness direction of the substrate. When the cross-sectional area of the reinforcement is not even, an average value of the cross-sectional areas measured at 5 or more sites is regarded as the “cross-sectional area of the reinforcement”.

According to the studies conducted by the present inventors on the relationship between the amount of strain applied to the connection and the cross-sectional area of the reinforcement, it has been proved that the nature thereof is too complicated to explain by a simple linear function although there is some relevance therebetween.

For example, while the amount of strain applied to the connection tends to decrease as the cross-sectional area of the reinforcement increases when the cross-sectional area of the reinforcement is relatively small, the amount of strain applied to the connection tends to increase as the cross-sectional area of the reinforcement increases when the cross-sectional area of the reinforcement is relatively large.

Therefore, analyzing the relationship between the amount of strain applied to the connection and the cross-sectional area of the reinforcement with high accuracy and optimizing the cross-sectional area of the reinforcement, such that the amount of strain applied to the connection is sufficiently small, is an effective means for securing the strength of the connection between the element and the substrate that constitute the semiconductor device.

In the method of the present disclosure, the method for preparing a simulation model of the semiconductor device is not particularly limited. For example, a simulation model may be produced by performing a structural analysis on the semiconductor device using a structural analysis system.

In the method of the present disclosure, it is preferred that multiple simulation models with different cross-section areas of the reinforcement are prepared.

By calculating the amount of strain from multiple simulation models with different cross-section areas of the reinforcement, the relationship between the cross-section area of the reinforcement and the amount of strain can be analyzed with more accuracy. As a result, a semiconductor device in which the cross-sectional area of the reinforcement is optimized so that the amount of strain is sufficiently small can be effectively achieved.

From the viewpoint of the accuracy of the amount of strain applied to the connection calculated from a simulation model, the simulation model is preferably constructed based on various kinds of parameters.

Exemplary parameters include the physical properties of the materials that constitute the semiconductor device, and the conditions for a process of connecting the substrate and the element.

Exemplary physical properties of the materials that constitute the semiconductor device include storage elastic modulus, glass transition temperature (Tg), thermal expansion coefficient (CTE) and Poisson's ratio.

Exemplary conditions for a process of connecting the substrate and the element include a heating temperature and a heating time.

The simulation method according to the present disclosure may further include deriving an approximate curve from the cross-sectional area X of the reinforcement, and the amount of strain Y that is calculated using the simulation model.

The approximate curve derived from the cross-sectional area X of the reinforcement and the amount of strain Y that is calculated using the simulation model may be used, for example, for determining the cross-sectional area of the reinforcement to be disposed at the periphery of the element in the production of a semiconductor device. By determining the cross-sectional area X of the reinforcement so that the amount of strain Y expressed by the approximate curve is less than a prescribed value, it is possible to design a semiconductor device in which the cross-sectional area X of the reinforcement is optimized so that the amount of strain Y is sufficiently small.

The approximate curve derived from the cross-sectional area X of the reinforcement in a simulation model and the amount of strain Y calculated using the simulation model may be a polynomial approximate curve of degree N, represented by the following formula (1):

$$Y = {aX}^{N} + {cX}^{( N - 1 )} + {dX}^{( N - 2 )} + … + b \qquad Formula ( 1 )$$

wherein, in formula (1), a, b, c and d are arbitrary constants and N is an integer of 2 or more.

From the viewpoint of accuracy of the analysis on the relationship between the cross-sectional area X of the reinforcement and the amount of strain Y, the value of N is preferably as large as possible. For example, the value of N is preferably 3 or more.

The value of N may be adjusted by the number of simulation models used for the derivation of the approximate curve.

### <Method of Producing Semiconductor Device>

The method of producing a semiconductor device according to the present disclosure is a method of producing a semiconductor device that includes a substrate, an element, a connection that electrically connects the substrate and the element, and a reinforcement that is disposed at a periphery of the element, the method including determining a cross-sectional area X of the reinforcement based on an amount of strain Y applied to the connection.

The semiconductor device produced by the foregoing method exhibits excellent strength of the connection between the substrate and the element.

From the viewpoint of securing a sufficient degree of strength of the connection, the cross-sectional area X of the reinforcement is preferably determined so as to satisfy the following formula (2):

$${X}_{min} \times 0.7 \leq X \leq {X}_{min} \times 1.3 \qquad Formula ( 2 )$$

wherein, in formula (2), Xₘᵢₙ represents a cross-sectional area of the reinforcement when an amount of strain Y applied to the connection is at a minimum.

In the method of producing the semiconductor device, the method of determining the cross-sectional area X of the reinforcement based on the amount of strain Y applied to the connection is not particularly limited. For example, the determination may be conducted by the simulation method as mentioned above or by the other methods. An example of the other methods is a method of preparing a sample of the semiconductor device of the subject, and measuring the actual amount of strain applied to the connection of the sample.

The method of manufacturing the semiconductor device is not particularly limited, and may be selected from ordinary methods.

For example, the semiconductor device may be manufactured by performing a thermal treatment on the element that is disposed at the substrate via the connection such as a solder bump, so as to electrically connect the element with the substrate, and subsequently disposing the reinforcement at a periphery of the element. As necessary, the outer periphery of the element may be further sealed with a sealant.

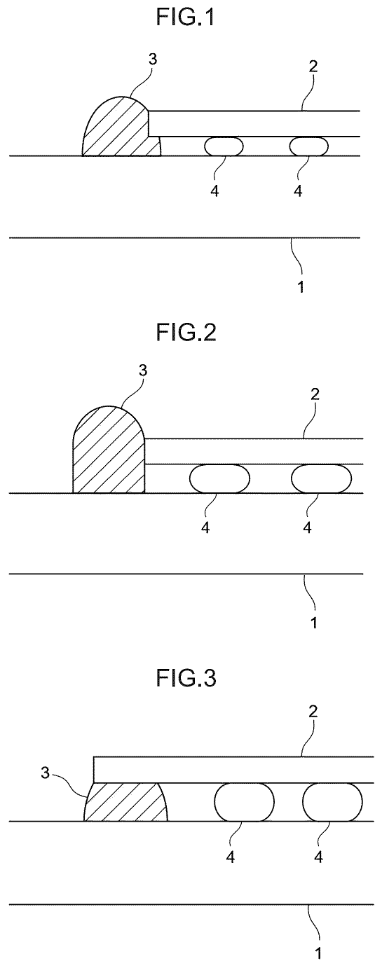

In the semiconductor device produced by the method of the present disclosure, the configuration of the reinforcement disposed at a periphery of the element is not particularly limited. FIG. 1 to FIG. 3 are the schematic sectional views illustrating the exemplary configurations of the reinforcement.

As shown in FIG. 1 to FIG. 3, the substrate 1 and the element 2 that constitute the semiconductor device 10 are electrically connected by the connection 4, and the reinforcement 3 is disposed at a periphery of the element 2.

The section of the reinforcement 3 may have a configuration that contacts a surface of the substrate 1, a lateral side of the element 2 and a back side (a side facing the substrate) of the element 2, as shown in FIG. 1; a configuration that contacts a surface of the substrate 1 and a lateral side of the element 2, as shown in FIG. 2; or a configuration that contacts a surface of the substrate 1 and the back side of the element 2, as shown in FIG. 3.

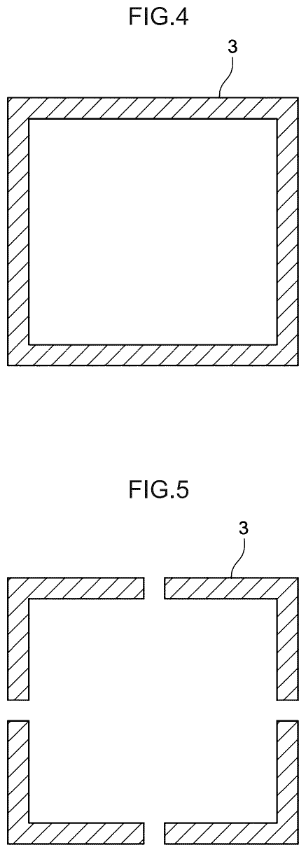

The reinforcement 3 may be disposed at the entire periphery of the element or may be disposed at a part of the periphery of the element. FIG. 4 and FIG. 5 are schematic plan view illustrating the locations at which the reinforcement is disposed. The reinforcement 3 may be disposed at a periphery of the element in a continuous manner, as shown in FIG. 4, or may be disposed a periphery of the element in a non-continuous manner, as shown in FIG. 5.

The distance between the substrate and the element (when the distance is not even, the distance at a periphery of the element) is not particularly limited, and may be selected depending on the size, the type or the like of the element. For example, the distance between the substrate and the element may be selected from a range of from 50 μm to 100 μm.

The height of the reinforcement (when the height is not even, the maximum value of the height) is not particularly limited, and may be selected depending on the size, the type or the like of the semiconductor device. For example, the height of the reinforcement may be selected from a range of from 50 μm to 1000 μm.

The width of the reinforcement (when the width is not even, the maximum value of the width) is not particularly limited, and may be selected depending on the size, the type or the like of the semiconductor device. For example, the width of the reinforcement may be selected from a range of from 50 μm to 1000 μm.

The type of the substrate and the element in the semiconductor device is not particularly limited, and may be selected depending on the purpose of the semiconductor device, and the like.

The type of the reinforcement in the semiconductor device is not particularly limited, and may be selected depending on the purpose of the semiconductor device, and the like. From the viewpoint of the mechanical strength, heat resistance and the like, the reinforcement is preferably a cured product of a curable resin composition. In the present disclosure, the curable resin composition refers to a composition that includes at least a curable resin and optionally the other components.

Specific examples of the curable resin include thermally-curable resins such as epoxy resin, phenol resin, melamine resin, unsaturated polyester resin, and ultraviolet-curable resins such as acrylic resin. Among these resins, epoxy resin is preferred.

From the viewpoint of forming the reinforcement with a desired shape at a periphery of the element, the reinforcement is preferably a cured product of a curable resin composition that is in a liquid state at a range of from 25° C. to 50° C.

The curable resin composition that is in a liquid state at a range of from 25° C. to 50° C. is readily applied to a desired region of the periphery of the element. Further, it is easy to form a configuration in which a cured product of the curable resin composition is disposed at a periphery of the element by curing the curable resin composition after the application thereof.

In the present disclosure, the term “being in a liquid state at a range of from 25° C. to 50° C.” refers to being in a liquid state at each temperature in a range of from 25° C. to 50° C.

The curable resin composition preferably has a viscosity at from 25° C. to 50° C. of 10 Pa·s or more, more preferably 20 Pa·s or more, further preferably 30 Pa·s or more.

When the curable resin composition has a viscosity at from 25° C. to 50° C. of 10 Pa·s or more, it is easy to maintain the initial configuration of the curable resin composition even if the curable resin composition is left to stand without curing after the application thereof.

The curable resin composition preferably has a viscosity at 25° C. of 300 Pa·s or less, more preferably 250 Pa·s or less, further preferably 230 Pa·s or less.

When the curable resin composition has a viscosity at 25° C. of 300 Pa·s or less, it is possible to perform the application of the curable resin composition with a machine that is capable of performing local application, such as a dispenser, a screen printer or an ink jet printer, thereby achieving favorable operation efficiency.

The viscosity at 50° C. of the curable resin composition is not particularly limited, and may be 200 Pa·s or less, 180 Pa·s or less, or 150 Pa·s or less, for example.

The viscosity of the curable resin composition is measured by a method described in the Examples.

The properties of a cured product of the curable resin composition is not particularly limited, and may be selected depending on the purpose of the structure or the like.

From the viewpoint of the connection reliability, the cured product of the curable resin composition preferably has a thermal expansion coefficient (CTE at a range not greater than the glass transition temperature, referred to as CTE 1) of 25 ppm/° C. or less, more preferably 22 ppm/° C. or less, further preferably 20 ppm/° C. or less. The cured product of the curable resin composition preferably has a thermal expansion coefficient (CTE at a range not less than the glass transition temperature, referred to as CTE 2) of 80 ppm/° C. or less, more preferably 75 ppm/° C. or less, further preferably 70 ppm/° C. or less.

From the viewpoint of heat resistance, the cured product of the curable resin composition preferably has a glass transition temperature (Tg) of 100° C. or more, more preferably 120° C. or more, further preferably 140° C. or more.

The CTE 1, CTE 2 and Tg of the cured product of the curable resin composition are measured by the methods described in the Examples.

The temperature at which the curable resin composition is cured (curing temperature) is not particularly limited. From the viewpoint of operability, the curing temperature is preferably 200° C. or less, more preferably 170° C. or less, further preferably 150° C. or less. The curing temperature is preferably 80° C. or more, more preferably 90° C. or more, further preferably 100° C. or more.

In the following, the epoxy resin composition that includes an epoxy resin and a curing agent is explained as an example of the curable resin composition.

The epoxy resin composition may include a component that is liquid at 25° C. and a component that is solid at 25° C., as an epoxy resin and a curing agent in combination. For example, the epoxy resin composition may include an epoxy resin that is liquid at 25° C. and a curing agent that is solid at 25° C. When a component that is liquid at 25° C. and a component that is solid at 25° C. are used as an epoxy resin and a curing agent, an epoxy resin composition that is liquid at a range of from 25° C. to 50° C. and has a thixotropic index of 1.0 or more at a range of from 25° C. to 50° C. tends to be readily obtained.

### [Epoxy Resin]

The type of the epoxy resin included in the epoxy resin composition is not particularly limited. Exemplary epoxy resins include bisphenol-type epoxy resin, naphthalene-type epoxy resin, glycidyl amine-type epoxy resin, hydrogenated bisphenol-type epoxy resin, alicyclic epoxy resin, alcohol ether-type epoxy resin, cyclic aliphatic epoxy resin, fluorene-type epoxy resin, and siloxane-type epoxy resin. The epoxy resin composition may include a single kind of epoxy resin alone, or may include a combination of two or more kinds.

In view of the balance in the properties of the epoxy resin composition, bisphenol-type epoxy resin and glycidyl amine-type epoxy resin are preferred as the epoxy resin.

Specific examples of the bisphenol-type epoxy resin include bisphenol A-type epoxy resin, bisphenol F-type epoxy resin and bisphenol AD-type epoxy resin. Among these, the bisphenol-type epoxy resin is preferably bisphenol-type epoxy resin that is liquid at 25° C., more preferably bisphenol F-type epoxy resin that is liquid at 25° C.

Examples of the commercial products of bisphenol F-type epoxy resin that is liquid at 25° C. include Epotohto YDF-8170C available from Nippon Steel & Sumikin Materials Co., Ltd. When the epoxy resin composition includes bisphenol-type epoxy resin, the proportion thereof with respect to the total epoxy resin is not particularly limited, and may be selected depending on the desired properties of the epoxy resin composition. For example, the proportion of bisphenol-type epoxy resin with respect to the total epoxy resin may be from 30% by mass to 100% by mass, from 40% by mass to 90% by mass, or from 50% by mass to 70% by mass.

Specific examples of the glycidyl amine-type epoxy resin include diglycidyl amine-epoxy resins and tri-or-more functional glycidyl amine-type epoxy resins. Among these, the glycidyl amine-type epoxy resin is preferably glycidyl amine-type epoxy resin that is liquid at 25° C.

Examples of the glycidyl amine-type epoxy resin that is liquid at 25° C. include triglycidyl-p-aminophenol. Examples of the commercial products of triglycidyl-p-aminophenol include jER-630 and jER-630 LSD available from Mitsubishi Chemical Corporation, and EP-3950 S available from ADEKA Corporation.

When the epoxy resin composition includes glycidyl amine-type epoxy resin, the proportion thereof with respect to the total epoxy resin is not particularly limited, and may be selected depending on the desired properties of the epoxy resin composition. For example, the proportion of glycidyl amine-type epoxy resin with respect to the total epoxy resin may be from 10% by mass to 100% by mass, from 20% by mass to 70% by mass, or from 30% by mass to 50% by mass.

### [Curing Agent]

The type of the curing agent included in the epoxy resin composition is not particularly limited. Exemplary curing agents include amine curing agent, phenol curing agent, acid anhydride curing agent, polymercaptan curing agent, polyaminoamide curing agent, isocyanate curing agent and block isocyanate curing agent. The epoxy resin composition may include a single kind of the curing agent alone, or may include two or more kinds of the curing agent in combination.

In view of the balance in the properties of the epoxy resin composition, amine curing agent is preferred as the curing agent.

Specific examples of the amine curing agent include aliphatic amine compounds such as diethylene triamine, triethylene tetramine, n-propylamine, 2-hydroxyethylamino propylamine, cyclohexylamine and 4,4′-diamino-dicyclohexylmethane, aromatic amine compounds such as diethyltoluene diamine, 3,3′-diethyl-4,4′-diamino diphenylmethane and 2-methylaniline, imidazole compounds such as imidazole, 2-methylimidazole, 2-ethylimidazole and 2-isopropylimidazole, and imidazoline compounds such as imidazoline, 2-methylimidazoline and 2-ethylimidazoline.

The curing agent included in the epoxy resin composition may be liquid at 25° C. or solid at 25° C. From the viewpoint of a balance between the ease of application using a dispenser, a screen printer or an ink jet printer and the shape-retainability, the curing agent is preferably a curing agent that is solid at 25° C., more preferably an amine curing agent that is solid at 25° C.

Examples of the amine curing agent that is solid at 25° C. include the aliphatic amine compounds as described above.

Examples of the commercial products of the amine curing agent that is solid at 25° C. include Fujicure FXR-1020, Fujicure FXR-1030, Fujicure FXR-1081 and Fujicure FXR-1121, available from T&K Toka Co., Ltd.

The compound ratio of the epoxy resin and the curing agent included in the epoxy resin composition is preferably determined such that the ratio of the number of functional group (active hydrogen in a case of amine curing agent) of the curing agent with respect to the number of epoxy group of the epoxy resin (number of functional group of curing agent/number of epoxy group of epoxy resin) is from 0.5 to 2.0, more preferably from 0.6 to 1.3, further preferably from 0.8 to 1.2, from the viewpoint of suppressing the amount of unreacted components.

### [Inorganic Filler]

The epoxy resin composition may include an inorganic filler. It is possible to reduce the thermal expansion coefficient or improve the thermal conductivity of the cured product of the epoxy resin composition, by including an inorganic filler in the epoxy resin composition.

Specific examples of the inorganic filler include silica, alumina, calcium carbonate, zirconium silicate, calcium silicate, silicon nitride, aluminum nitride, boron nitride, beryllia, zirconia, zircon, forsterite, steatite, spinel, mullite, titania, talc, clay and mica.

Among these inorganic fillers, silica is preferred from the viewpoint of reducing the thermal expansion coefficient, and alumina is preferred from the viewpoint of improving the thermal conductivity. The epoxy resin composition may include a single kind of the inorganic filler alone, or may include two or more kinds of the inorganic filler in combination.

The content of the inorganic filler included in the epoxy resin composition is not particularly limited. From the viewpoint of reducing the thermal expansion coefficient and improving the thermal conductivity of the cured product, the content of the inorganic filler with respect to the total epoxy resin composition is preferably 40% by mass or more, more preferably 50% by mass or more, further preferably 60% by mass or more. From the viewpoint of suppressing an increase in the viscosity of the epoxy resin composition, the content of the inorganic filler with respect to the total reinforcement is preferably 90% by mass or less, more preferably 80% by mass or less, further preferably 75% by mass or less.

When the inorganic filler has a particulate shape, the average particle size thereof is not particularly limited. For example, the volume average particle size of the inorganic filler is preferably from 0.05 μm to 20 μm, more preferably from 0.1 μm to 15 μm. When the volume average particle size is 0.05 μm or more, an increase in viscosity of the reinforcement tends to be more suppressed. When the volume average particle size is 20 μm or less, application properties to a narrow gap tends to improve.

The volume average particle size of the inorganic filler refers to a particle size (D50) corresponding to an accumulation from a smaller size of 50% in a volume-based particle size distribution obtained with a laser scattering/diffraction particle size distribution meter.

### [Additives]

The epoxy resin composition may include various kinds of additives such as a thixotropy-imparting agent, a curing accelerator, a stress-relaxation agent, a coupling agent, or a colorant.

When the epoxy resin composition incudes a component other than the epoxy resin, the curing agent and the inorganic filler, the total content thereof with respect to the total epoxy resin composition is preferably 10% by mass or less, more preferably 5% by mass or less.

### <Semiconductor Device>

The semiconductor device according to the present disclosure is a semiconductor device that includes a substrate, an element, a connection that electrically connects the substrate and the element, and a reinforcement that is disposed at a periphery of the element, the reinforcement having a cross-sectional area X that satisfies the following formula (2):

$${X}_{min} \times 0.7 \leq X \leq {X}_{min} \times 1.3 \qquad Formula ( 2 )$$

wherein, in formula (2), Xₘᵢₙ represents a cross-sectional area of the reinforcement when an amount of strain Y applied to the connection is at a minimum.

The semiconductor device according to the present disclosure exhibits excellent strength of the connection between the substrate and the element.

The details and preferred embodiments of the members included in the semiconductor device are the same as the details and preferred embodiments of the members included in the semiconductor device that is produced by the method for producing a semiconductor device as described above.

### Examples

In the following, the present disclosure is explained in more details by referring to the examples. However, the scope of the present disclosure is not limited to these examples.

### (Structural Analysis of Semiconductor Device)

Structural analysis was performed on a semiconductor device used for the reliability test, using a structural analysis software (Marc 2021, MSC Software Corporation). Specifically, one of the four regions obtained by dividing each side of the semiconductor device in half was used as a subject for the structural analysis. Further, five simulation models with different values of cross-sectional area A as shown in Table 1 were prepared. An 8-node hexahedron was regarded as the elemental class. In order to shorten the time for calculation, the analysis was conducted by zooming analysis.

A global model was prepared with rough elements and subjected to calculation by a computer using a structural analysis software. Based on the calculation results, a simulation model was prepared with finer elements as a local model at a portion at which the amount of strain applied to the connection of the semiconductor device was at a maximum.

Subsequently, the amount of displacement in the directions of X, Y and Z, obtained from the calculation results of the global model, was input to the local model and calculated by a computer, whereby the maximum amount of total equivalent plastic strain was output. The results are shown in Table 1.

TABLE 1

| Items | | Model 1 | Model 2 | Model 3 | Model 4 | Model 5 |
|---|---|---|---|---|---|---|
| Cross-sectional area X (mm²) | | 0.36 | 0.73 | 0.91 | 1.36 | 1.82 |
| Global model | Number of nodes | 23,652 | 24,942 | 25,412 | 25,902 | 25,902 |
| | Number of elements | 20,344 | 21,574 | 22,024 | 22,494 | 22,494 |

| | | |
|---|---|---|
| Local model | Number of nodes | 41,454 |
| | Number of elements | 38,896 |

| | | | | | |
|---|---|---|---|---|---|
| Amount of strain Y | 0.0358 | 0.0334 | 0.0337 | 0.0351 | 0.0366 |

### (Input Items for Simulation Model)

To the simulation model as prepared, storage elastic modulus, thermal expansion coefficient (CTE), glass transition temperature (Tg) and Poisson's ratio of the materials shown in Table 2 were input. Si and Cu were regarded as an elastic body, SAC (solder) was regarded as an elasto-plastic body, and the other materials were regarded as a viscoelastic body in order to take into account the relaxation properties. The yield stress of the solder for the input was 29 MPa at −40° C. or 12.6 MPa at 130° C.

As to the temperature conditions, a step consisting of starting at the initial temperature of 220° C. for the solder to melt, decreasing the temperature from 220° C. to room temperature (20° C.), increasing the temperature from room temperature to 125° C. and retaining at 125° C. for 13 minutes, and decreasing the temperature from 125° C. to −55° C. and retaining at −55° C. for 13 minutes, was repeated for eleven times (11 cycles). The eleventh step was terminated after the temperature was retained at 125° C. for 13 minutes. The time for increasing the temperature and the time for decreasing the temperature were 2 minutes, respectively.

TABLE 2

| | Storage | | | | |
|---|---|---|---|---|---|
| | elastic | | | | Poisson's |
| | modulus at | CTE1 | CTE2 | Tg | ratio |
| Materials | 25° C. (GPa) | (ppm/° C.) | (ppm/° C.) | (° C.) | (—) |
| Si | 167 | 3.2 | — | — | 0.27 |
| PBO | 2.55 | 64.8 | — | 223 | 0.30 |
| Cu | 100 | 17.0 | — | — | 0.34 |
| PI | 4.15 | 65.9 | 178.0 | 175 | 0.37 |
| SAC (solder) | 37.4 | 21.7 | | — | 0.41 |
| Core | 29.0 | 14.5 | 12.8 | 180 | 0.30 |
| SR | 3.90 | 30.0 | 95.0 | 125 | 0.30 |
| Buildup | 8.13 | 46.0 | 120.0 | 153 | 0.30 |
| EB | 10.9 | 19.0 | 71.0 | 153 | 0.30 |
| (reinforcement) | | | | | |

### (Preparation of Resin Composition)

A resin composition was prepared by mixing the materials shown in Table 3. The details of the materials are described below. The compound ratio of the epoxy resin and the curing agent was set such that the number of epoxy group of the epoxy resin was equal to the number of active hydrogen of the curing agent. The properties of the resin composition and a cured product thereof were prepared by the methods as described below. The results are shown in Table 3.
Epoxy Resin 1: bisphenol F epoxy resin that is liquid at 25° C.
Epoxy Resin 2: triglycidyl-p-aminophenol that is liquid at 25° C.
Curing Agent: aliphatic amine that is solid at 25° C.
Thixotropy-imparting Agent: aerosil silica with a primary particle size of 10 nm to 20 nm
Inorganic Filler: spherical silica with a volume-average particle size of 30 μm
Colorant: carbon black, product name “MA-100”, Mitsubishi Chemical Corporation

### (Measurement of Viscosity)

The viscosity at 10 rpm (rotation/minute) of the resin composition was measured at 25° C. using a dynamic viscometer (AR-2000, TA Instruments).

### (Measurement of CTE 1, CTE 2 and Tg)

The resin composition was subjected to a curing treatment at 120° C. for 15 minutes, thereby obtaining a cured product. A measurement sample having a size of 8 mm in diameter and 20 mm in length was prepared from the cured product.

The amount of change in length of the measurement sample when the temperature was increased from 0° C. to 240° C. at a rate of 5° C./min (linear coefficient of expansion) was measured by a compression method with a thermomechanical analyzer (TMA 2940, TA Instruments). The average value of the linear coefficient of expansion in the measurement temperature range of from 10° C. to 30° C. was regarded as CTE 1, and the average value of the linear coefficient of expansion in the measurement temperature range of from 180° C. to 220° C. was regarded as CTE 2. The temperature corresponding to a point of intersection of tangent lines at 100° C. and 200° C. was regarded as the glass transition temperature (Tg).

### (Measurement of Storage Elastic Modulus)

The resin composition was subjected to a curing treatment at 120° C. for 15 minutes, thereby obtaining a cured product. A measurement sample having a size of 60 mm×10 mm and 2 mm in thickness was prepared from the cured product.

The storage elastic modulus of the measurement sample was measured with a thermomechanical analyzer (Q 800, TA Instruments) by dual cantilever beam mode at a temperature range of from 0° C. to 260° C. at a rate of 3° C./min and a frequency of 1 Hz.

TABLE 3

| | | |
|---|---|---|
| Epoxy resin 1 | parts by mass | 30 |
| Epoxy resin 2 | parts by mass | 70 |
| Curing agent | equivalent ratio | 1.0 |
| Thixotropy-imparting agent | parts by mass | 2 |
| Inorganic filler | parts by mass | 313 |
| Inorganic filler content | % by mass | 68 |
| Colorant | parts by mass | 0.2 |

| | |
|---|---|
| Viscosity at 25° C. (Pa · s) | 166 |
| Tg (° C.) | 153 |
| CTE1 (ppm/° C.) | 18 |
| CTE2 (ppm/° C.) | 72 |
| Storage elastic modulus at 25° C. (GPa) | 10.7 |
| Storage elastic modulus at 240° C. (GPa) | 0.69 |

### (Preparation of Semiconductor Device)

A semiconductor device was prepared using the resin composition as prepared, and the substrate and the element.
Substrate: WALTS-KIT (WLP(S) 300P/400P-2, 30 mm×30 mm, thickness: 978 μm, Walts Co., Ltd.)
Element: WLP TEG M2 (0.4 mm-pitch BGA, 6 mm×6 mm, thickness: 725 μm, Walts Co., Ltd.)

A flux (SPARKLE FLUX WF-6400, Senju Metal Industry Co., Ltd.) was applied to the solder bump of the element. Subsequently, the element is temporarily bonded to the substrate with a flip chip bonder (FC 3000W, Toray Industries, Inc.) at 25° C., such that the center of the element matched the center of the substrate. Subsequently, the element and the substrate were subjected to a reflow treatment at a maximum temperature of 260° C. with a reflow furnace (SNR-1065 GT, Senju Metal Industry Co., Ltd.) Subsequently, the flux was removed in water at 80° C. with a flux washer (YWV-4635S, Sakura Seiki Co., Ltd.), thereby obtaining a structure in which the element was bonded to the substrate via the solder.

The resin composition (25° C.) was applied at the outer periphery of the element disposed on the substrate with a dispenser (FAD 2500, Musashi Engineering, Inc.) and a nozzle (TNPD-22G, Musashi Engineering, Inc.)

The resin composition was applied at a region corresponding to the outer periphery of the element with a width of 1.25 mm (Sample A) or at a region corresponding to the outer periphery of the element with a width of 1.88 mm (Sample B). Three samples were prepared for each of Sample A and Sample B, respectively.

The application was conducted with the dispenser at a pressure of 400 kPa, and at a rate of 5 mm/s (Sample A) or at a rate of 2.5 mm/s (Sample B).

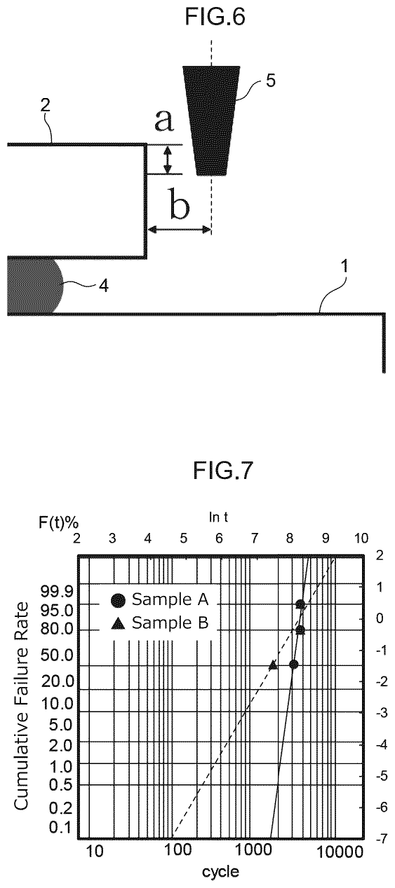

As shown in FIG. 6, the nozzle was located such that the distance in height a between the tip of the nozzle 5 and the upper side of the element 2 was 300 μm, and the distance b between the center of the nozzle 5 and the edge of the element 2 was 500 μm.

After the completion of the dispensing, the structure was subjected to a thermal treatment at 120° C. for 15 minutes to cure the resin composition, thereby forming the reinforcement at the outer periphery of the element.

### (Evaluation of Connection Reliability)

The connection reliability of the semiconductor, Samples A and B, was evaluated with a heat shock tester (NT 2031W, Kusumoto Chemicals, Ltd.) by the following method.

Prior to the test, the initial value of resistivity (R0) of the sample at the outer periphery of the element was measured. Subsequently, the sample was subjected to a test in which a step consisting of retaining the temperature at −55° C. for 15 minutes and retaining the temperature at 125° C. for 15 minutes was repeated for 100 times (100 cycles) with the heat shock tester.

After the test, the value of resistivity (Ri) of the sample was measured.

When a rate of increase of Ri with respect to R0 was less than 20%, the sample was subjected to the same test again. The test was terminated when a rate of increase of Ri with respect to R0 reached 20% or more.

A Weibull plot graph (shown in FIG. 7) was produced from the results of the heat shock test, and the number of cycles at a cumulative failure rate of 20% was calculated. The results are shown in Table 4. The values shown in Table 4 are an average value of each sample (n=3).

TABLE 4

| | Sample A | Sample B |
|---|---|---|
| Width of reinforcement (mm) | 1.25 | 1.88 |
| Cross-sectional area of | 0.62 | 1.04 |
| reinforcement (mm²) | | |
| Number of cycles at 20% | 3104 | 1683 |
| cumulative failure (cycles) | | |

### (Verification of Simulation Results)

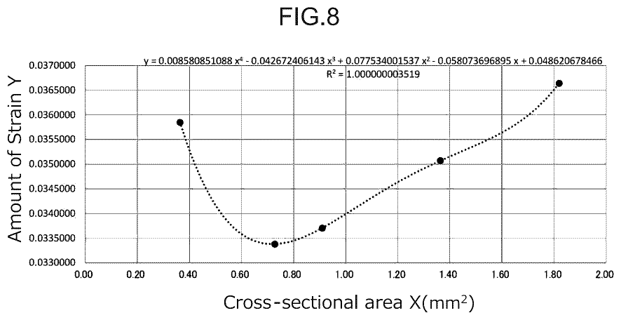

A scatter diagram was prepared from the cross-sectional area X of the reinforcement in the simulation model and the amount of strain Y calculated from the simulation model, and an approximate curve was derived therefrom. The results are shown in FIG. 8.

As shown in FIG. 8, when the cross-sectional area of the reinforcement in the simulation model is relatively small, the amount of strain applied to the connection tends to decrease as the cross-sectional area increases. Meanwhile, when the cross-sectional area of the reinforcement in the simulation model is relatively large, the amount of strain applied to the connection tends to increase as the cross-sectional area increases.

Further, the tendency shown in GIF. 8 matched the results of evaluation of the connection reliability of the actually prepared semiconductor devices.

1. A simulation method, comprising:
preparing a simulation model of a semiconductor device that comprises a substrate, an element, a connection that electrically connects the substrate and the element, and a reinforcement that is disposed at a periphery of the element; and
calculating an amount of strain applied to the connection in the simulation model.

2. The simulation method according to claim 1, further comprising deriving a polynomial approximate curve of degree N, represented by the following formula (1):
$$Y = {aX}^{N} + {cX}^{( N - 1 )} + {dX}^{( N - 2 )} + … + b \qquad Formula ( 1 )$$
wherein, in formula (1), a, b, c and d are arbitrary constants and N is an integer of 2 or more.

3. The simulation method according to claim 1, wherein the simulation model is produced using a structural analysis software.

4. A method for producing a semiconductor device that comprises a substrate, an element, a connection that electrically connects the substrate and the element, and a reinforcement that is disposed at a periphery of the element,
the method comprising determining a cross-sectional area X of the reinforcement based on an amount of strain Y applied to the connection.

5. The method for producing a semiconductor device according to claim 4, wherein the cross-sectional area X of the reinforcement satisfies the following formula (2):
$${X}_{min} \times 0.7 \leq X \leq {X}_{min} \times 1.3 \qquad Formula ( 2 )$$
wherein, in formula (2), Xₘᵢₙ represents a cross-sectional area of the reinforcement when an amount of strain Y applied to the connection is at a minimum.

6. The method for producing a semiconductor device according to claim 4, wherein the amount of strain Y applied to the connection is calculated using a simulation model.

7. The method for producing a semiconductor device according to claim 4, wherein the reinforcement is a cured product of a curable resin composition.

8. The method for producing a semiconductor device according to claim 7, wherein the curable resin composition comprises an epoxy resin.

9. The method for producing a semiconductor device according to claim 5, wherein the reinforcement has a glass transition temperature (Tg) of 100° C. or more, a thermal expansion coefficient in a region of not greater than the glass transition temperature (CTE 1) of 25 ppm/° C. or less, and a thermal expansion coefficient in a region of not less than the glass transition temperature (CTE 2) of 80 ppm/° C. or less.

10. A semiconductor device that comprises a substrate, an element, a connection that electrically connects the substrate and the element, and a reinforcement that is disposed at a periphery of the element, the reinforcement having a cross-sectional area X that satisfies the following formula (2):
$${X}_{min} \times 0.7 \leq X \leq {X}_{min} \times 1.3 \qquad Formula ( 2 )$$
wherein, in formula (2), Xₘᵢₙ represents a cross-sectional area of the reinforcement when an amount of strain Y applied to the connection is at a minimum.

11. The semiconductor device according to claim 10, wherein the reinforcement is a cured product of a curable resin composition.

12. The semiconductor device according to claim 10, wherein the curable resin composition comprises an epoxy resin.

13. The semiconductor device according to claim 10, wherein the reinforcement has a glass transition temperature (Tg) of 100° C. or more, a thermal expansion coefficient in a region of not greater than the glass transition temperature (CTE 1) of 25 ppm/° C. or less, and a thermal expansion coefficient in a region of not less than the glass transition temperature (CTE 2) of 80 ppm/° C. or less.
